(19) United States
(12) Patent Application Publication
(10) Pub. No.: US 2024/0123579 A1
(43) Pub. Date: Apr. 18, 2024

(54) Installation Tool for a Rotational Coupling Device, Rotational Coupling Device and Installation Tool Kit and Method of Installing a Rotational Coupling Device

(71) Applicant: Warner Electric Technology LLC, Braintree, MA (US)

(72) Inventors: Gary Haasch, Rockton, IL (US); Brian Keith Holmbeck, Sharon, WI (US); George Lankford, Beloit, WI (US)

(21) Appl. No.: 18/488,431

(22) Filed: Oct. 17, 2023

Related U.S. Application Data
(60) Provisional application No. 63/416,641, filed on Oct. 17, 2022.

(51) Int. Cl. B25B 13/50; B25B 13/04; B25B 13/06

(52) U.S. Cl. CPC B25B 13/5008; B25B 13/04; B25B 13/065

(57) ABSTRACT

A tool for installing a rotational coupling device on a shaft, a rotational coupling device and installation tool kit, and a method of installing a rotational coupling device are provided. The coupling device includes a hub disposed about an axis of the shaft and spaced from the shaft. A bore in the hub is aligned with a bore in the shaft and receives a fastener extending through the hub bore and into the shaft bore. The tool includes a body defining an aperture having a shape complementary to a shape of the hub and defining at least one flat and an arm extending from the body in a direction perpendicular to, and away from, the axis. At least a portion of the arm is axially spaced from the hub allowing the tool to access deeply recessed hubs and prevent rotation of the device and shaft as the fastener is rotated.

### BACKGROUND OF THE INVENTION

### a. Field of the Invention

This invention relates to installation of a rotational coupling device such as a clutch or brake onto a shaft. In particular, the invention relates to an installation tool for a rotational coupling device, a rotational coupling device and installation tool kit, and a method of installing a rotational coupling device that allows the rotational coupling device and shaft to be fixed against rotational movement as a fastener used to affix the rotational coupling device to the shaft is rotated to thereby maintain the rotational alignment of the rotational coupling device and shaft and tightening of the fastener to the desired torque.

### b. Background Art

A rotational coupling device such as clutch or brake is used to control the transfer of torque between two bodies. The device includes components such as a rotor coupled to one body and components such as an armature coupled to the other body. The rotor and armature are selectively engaged to transfer torque between the bodies.

In certain applications, one of the bodies may comprise a shaft on which the rotational coupling device is mounted while the other of the bodies may comprise a pulley supported on the rotational coupling device. Some conventional rotational coupling device include a pair of spaced hubs—one of which is disposed about the shaft and supports one of the rotor and armature and other of which is spaced from the shaft and supports the other of the rotor and armature. The hub that is spaced from the shaft may be aligned with the shaft using a key that is disposed in aligned keyways in the shaft and the hub. A fastener extending through a bore in the hub and into a corresponding bore in the shaft may be then be used to secure the rotational coupling device to the shaft.

During installation of the rotational coupling device on the shaft, rotation of the fastener used to secure the rotational coupling device to the shaft can cause corresponding rotation of the shaft. This action may result in an inability to tighten the fastener to the desired torque. In order to prevent rotation of the shaft, the hub that is spaced from the shaft is shaped in a manner that allows the hub to be grasped by a tool so that both the hub and shaft can be held against rotation as the fastener is rotated. In some conventional rotational coupling devices, however, the hub is recessed relatively far within the pulley or another component of the device supported on the hub. In such devices, conventional wrenches and other tools often cannot reach the hub to grasp the hub and/or interfere with other tools used to rotate the fastener. Installers therefore often resort to time-consuming and/or unsafe methods to engage the hub and prevent rotation of the hub and shaft.

The inventors herein have recognized a need for an installation tool for a rotational coupling device, a rotational coupling device and installation tool kit and method of installing a rotational coupling device that will minimize and/or eliminate one or more of the above-identified deficiencies.

### BRIEF SUMMARY OF THE INVENTION

This invention relates to installation of a rotational coupling device such as a clutch or brake onto a shaft. In particular, the invention relates to an installation tool for a rotational coupling device, a rotational coupling device and installation tool kit, and a method of installing a rotational coupling device that allows the rotational coupling device to be fixed against rotational movement as a fastener used to affix the rotational coupling device to the shaft is rotated to thereby maintain the rotational alignment of the rotational coupling device and shaft and tightening of the fastener to the desired torque.

A tool for installing a rotational coupling device on a shaft in accordance with one embodiment includes a body defining an aperture configured to be positioned about an axis extending through the shaft, a hub of the rotational coupling device and a fastener extending through the hub and into the shaft. The aperture has a shape complementary to a shape of the hub of the rotational coupling device and defines at least one flat. The tool further includes an arm extending from the body. The arm includes an axially extending portion extending from the body in a direction parallel to the axis and a radially extending portion extending from the axially extending portion in a direction perpendicular to, and away from, the axis.

A tool for installing a rotational coupling device on a shaft in accordance with another embodiment includes a body defining an aperture configured to be positioned about an axis extending through the shaft, a hub of the rotational coupling device and a fastener extending through the hub and into the shaft. The aperture has a shape complementary to a shape of the hub of the rotational coupling device and defines at least one flat. The body has a first axial end configured to receive the hub and a second axial end spaced from the hub. The tool further includes an arm extending from the second axial end of the body in a direction perpendicular to, and away from, the axis.

A rotational coupling device and installation tool kit in accordance with one embodiment includes a rotational coupling device configured for mounting on a shaft. The rotational coupling device has a hub configured to be disposed about a rotational axis of the shaft and spaced from the shaft. The hub has a bore configured to be centered about the rotational axis, aligned with a corresponding bore in the shaft and receive a fastener extending along the rotational axis and through the bore in the hub and into the bore in the shaft. The rotational coupling device and installation tool kit further includes a tool for installing the rotational coupling device on the shaft. The tool includes a body defining an aperture configured to be positioned about the rotational axis and receive the hub of the rotational coupling device. The aperture has a shape complementary to a shape of the hub and defines at least one flat. The tool further includes an arm extending from the body. A least a portion of the arm is configured to be axially spaced from the hub and extends in a direction perpendicular to, and away from, the rotational axis. The tool is configured to be fixed against movement about the rotational axis as the fastener is rotated into the hub of the rotational coupling device and the shaft.

A method for installing a rotational coupling device in accordance with one embodiment includes mounting a rotational coupling device onto a shaft such that a hub of the rotational coupling device is disposed about a rotational axis of the shaft and spaced from the shaft. The hub has a bore configured to be centered about the rotational axis and aligned with a corresponding bore in the shaft. The method further includes moving a tool along the rotational axis and into engagement with the hub. The tool includes a body defining an aperture having a shape complementary to a shape of the hub of the rotational coupling device and defining at least one flat. The tool further includes an arm extending from the body in a direction perpendicular to, and away from, the rotational axis. At least a portion of the arm is axially spaced from the hub of the rotational coupling device. The method further includes inserting a fastener through the bore of the hub and into the bore of the shaft and rotating the fastener about the rotational axis while preventing rotation of the tool about the rotational axis to thereby prevent rotation of the hub of the rotational coupling device and the shaft.

An installation tool for a rotational coupling device, a rotational coupling device and installation tool kit and a method for installing a rotational coupling device in accordance with the present teachings represents an improvement as compared to conventional tools, kits and methods. In particular, the inventive tool, kit and method enables an installer to prevent rotation of the rotational coupling device hub, and therefore the shaft on which the rotational coupling device is mounted, during rotation of the fastener used to secure the rotational coupling device on the shaft even in devices where the hub is deeply recessed within a pulley or another component of the device. As a result, the alignment of the shaft and the rotational coupling device may be maintained and the fastener may be tightened to the desired torque without resorting to time-consuming and/or unsafe methods of engaging the hub and rotating the shaft.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a plan view of a rotational coupling device forming a part of one embodiment of a rotational coupling device and installation tool kit in accordance with the disclosed teachings.

FIG. 2 is a cross-sectional view of the rotational coupling device of FIG. 1.

FIG. 3 is a perspective view of a one embodiment of an installation tool for the rotational coupling device of FIGS. 1-2.

FIG. 4 is a perspective view of the rotational coupling device of FIGS. 1-2 and the installation tool of FIG. 3.

FIG. 5 is a perspective view of another embodiment of an installation tool for the rotational coupling device of FIGS. 1-2.

FIG. 6 is a flow chart illustrating one embodiment of a method of installing a rotational coupling device.

### DETAILED DESCRIPTION OF THE INVENTION

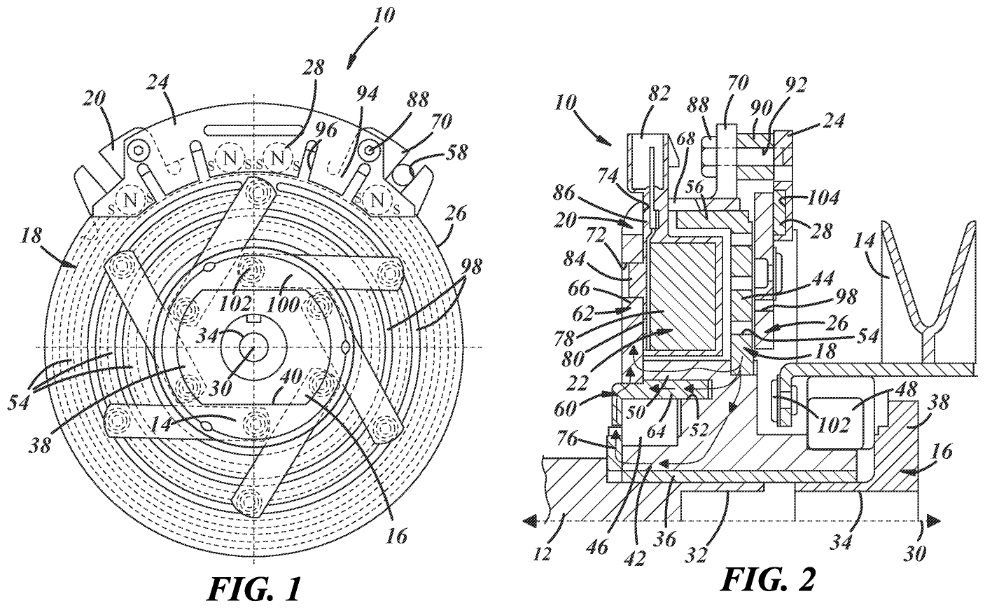

Referring now to the drawings wherein like reference numerals are used to identify identical components in the various views, FIGS. 1-2 illustrate a rotational coupling device 10 forming part of a rotational coupling device and installation tool kit in accordance with one embodiment of the invention. Device 10 functions as a clutch to selectively transfer torque from an input shaft 12 to an output member 14. Device 10 also functions as a brake on output member 14 when torque is not being transferred to output member 14. Device 10 may be provided for use in a riding lawnmower or similar device. It will be understood by those of ordinary skill in the art, however, that device 10 may be used in a wide variety of applications requiring a clutch or brake. Device 10 may include a spacer or hub 16, a rotor 18, an electromagnet including a field shell 20 and an electrical conduction assembly 22, a brake plate 24, an armature 26 and one or more permanent magnets 28.

Input shaft 12 provides a source of torque for driving output member 14. Shaft 12 may be made from conventional metals and metal alloys and may be solid or tubular. Shaft 12 is centered about a rotational axis 30 and is driven by an engine, electric motor or other conventional power source. Shaft 12 defines a bore 32 in one axial end configured to receive a fastener (not shown) such as a bolt extending through hub 16 and used to secure device 10 on shaft 12. The bore 32 may include a plurality of threads configured to engage corresponding threads on the fastener. In the illustrated embodiment input shaft 12 is inserted into device 10 on a side of device 10 opposite output member 14. It should be understood, however, that the orientation of input shaft 12 and hub 16 could be reversed such that input shaft 12 is inserted into device 10 on the same side as output member 14.

Output member 14 transfers torque to a driven device such as a lawnmower blade. Member 14 may comprise a conventional pulley around which a torque transmitting belt is wound and coupled to the driven device.

Hub 16 is provided to support output member 14 in assembled relation with the other components of device 10 and may be made from conventional materials including powdered metals. Hub 16 is disposed about, and may be centered about, axis 30. Hub 16 is generally annular in shape and defines a bore 34. Bore 34 is disposed about, and may be centered about axis 30, is aligned with bore 32 in shaft 12 and is configured to receive a fastener (not shown) that extends through bore 34 and into bore 32 and is used to secure clutch 10 onto input shaft 12. One axial end of hub 16 proximate input shaft 12 has a generally circular outer surface but defines a keyway configured to receive a key 36 of rotor 18 extending into aligned keyways in input shaft 12 and hub 16. The opposite axial end of hub 16 distal from input shaft 12 defines a flange 38. Referring to FIG. 1, flange 38 has a shape that defines one or more flats 40 that may be grasped or otherwise engaged by an installation tool as described in greater detail below. In the illustrated embodiment, flange 38 defines two diametrically opposed flats 40 separated from one another by a pair of arcuate or curved edges.

Referring again to FIG. 2, rotor 18 is provided for selective engagement with armature 26 to transmit torque between input shaft 12 and output member 14. Rotor 18 is disposed about axis 30 and is coupled to input shaft 12 for rotation therewith. Rotor 18 may be made from conventional metals and metal alloys and includes a hub 42 and a rotor disc 44.

Hub 42 is tubular and includes a radially inwardly extending key 36 configured to be received within the keyways of input shaft 12 and hub 16. Proximate each axial end, hub 42 supports bearings 46, 48. At its radially outermost diameter, hub 42 defines an axially extending inner rotor pole 50. Hub 42 further defines an axially extending recess 52 radially inwardly of pole 50 for a purpose described hereinbelow.

Disc 44 extends radially outwardly from hub 42. Disc 44 is coupled to hub 42 through, for example, a press-fit relationship including plurality of complementary lugs and notches. As is known in the art, disc 44 may include a plurality of radially spaced rows of angularly spaced, banana shaped slots 54. Upon energization of conduction assembly 22, slots 54 cause magnetic flux to travel back and forth between disc 44 and armature 26 across an air gap enabling a high torque engagement between rotor 18 and armature 26. In the illustrated embodiment, disc 44 includes three rows of slots 54. It should be understood, however, that the number of rows of slots 54, the number of slots 54 in any one row, and the size and shape of slots 54 may vary. At its outer diameter, disc 44 defines an axially extending outer rotor pole 56. Pole 56 is radially aligned with pole 50 and spaced radially outwardly of pole 50.

Field shell 20 is provided to house conduction assembly 22. Shell 20 also forms part of a magnetic circuit that causes the selective engagement of rotor 18 and armature 26. Field shell 20 may be made from conventional metals and metal alloys, including steel. Shell 20 is cylindrical and is disposed about axis 30. Referring to FIG. 1, shell 20 is fixed against rotation through, for example, a fastener 58 extending through a slot in shell 20. Referring again to FIG. 2, shell 20 is generally U-shaped in cross-section and includes radially inner and radially outer annular members 60, 62.

Inner member 60 is supported on an outer race of bearing 46. Member 60 is generally L-shaped in cross-section and defines an axially extending inner pole 64. Pole 64 extends into recess 52 of hub 42 of rotor 18 and is disposed radially inwardly of inner rotor pole 50.

Outer member 62 is coupled to and supported on inner member 60. Outer member 62 defines an end wall 66, an axially extending outer pole 68, and a flange 70. End wall 66 extends radially outwardly from member 60 and defines one or more recesses 72 for a purpose described hereinbelow. Pole 68 is integral with, and extends axially from, end wall 66. Pole 68 is disposed radially outwardly of pole 56 of rotor 18. An aperture 74 is also formed through pole 68 through which leads for conduction assembly 22 extend outward. Flange 70 is integral with, and extends radially outwardly from, pole 68 at an end of pole 68 opposite end wall 66. Referring to FIG. 1, flange 70 extends along at least a portion of the circumference of pole 68.

Conduction assembly 22 is provided to create a magnetic circuit among rotor 18, a spacer 76 (or hub 16 if the orientation of input shaft 12 is reversed), field shell 20, and armature 26 to cause movement of armature 26 into engagement with rotor 18 and transmission of torque from input shaft 12 to output member 14. Conduction assembly 22 is generally annular and is disposed about axis 30 within field shell 20. In particular, assembly 22 is disposed between the inner and outer poles 64, 68 of shell 20. Assembly 22 includes a conductor 78 and a shell 80.

Conductor 78 may comprise a conventional copper coil although other known conductors may alternatively be used. Conductor 78 may be connected electrically to a power supply (not shown) such as a battery. Upon energization of conductor 78, a magnetic circuit is formed between rotor 18, a spacer 76 (or hub 16 if the orientation of input shaft 12 is reversed), field shell 20, and armature 26. Magnetic flux flows from pole 68 of shell 20 across an air gap to pole 56 of rotor 18. Flux then travels back and forth between disc 44 and armature 26 across the air gap between them. Flux then flows from disc 44 to hub 42 of rotor 18 and back to members 60, 62 of field shell 20 along various paths as indicated by the arrows in FIG. 2.

Shell 80 is provided to house conductor 78 and is also used to mount conductor 78 within field shell 20. Shell 80 may be molded from conventional plastics. Shell 80 may include an integral terminal connector 82 through which conductor 78 may be electrically connected to a power source. Connector 82 may extend through aperture 74 in field shell 20. Shell 80 may also define one or more lugs 84 sized to be received within recesses 72 in end wall 66 to prevent rotation of conduction assembly 22. Shell 80 may further include a radially outwardly extending flange 86. disposed proximate outer pole 68 of field shell 20 that may be affixed to field shell 20 at a plurality of points.

Brake plate 24 provides a braking surface for engagement by armature 26 to brake output member 14. Brake plate 24 may be made from conventional materials having a relatively low magnetic reluctance including conventional metals and metal alloys such as steel. Brake plate 24 extends about at least a portion of the circumference of device 10 and is coupled to field shell 20. In particular, brake plate 24 is coupled to flange 70 of field shell 20 using one or more fasteners 88. Fasteners 88 may be made from nonmagnetic materials or materials having a relatively high magnetic reluctance to reduce or eliminate flux transfer between brake plate 24 and field shell 20 and thereby facilitate clutch engagement when conduction assembly 22 is energized. Brake plate 24 may be axially spaced from flange 70 of field shell 20 using one or more spacers 90. Spacers 90 may include bores 92 through which fasteners 88 extend. Spacers 90 may likewise be made from nonmagnetic materials or materials having a relatively high magnetic reluctance to reduce or eliminate flux transfer between brake plate 24 and field shell 20. Referring to FIG. 1, brake plate 24 may include one or more radially extending, arcuately spaced tabs 94 divided by radially extending, arcuately spaced slots 96 formed in brake plate 24 for a purpose described hereinbelow.

Armature 26 is provided to transmit a braking torque to output member 14 and to selectively transmit a drive torque from rotor 18 to output member 14. Armature 26 may be made from a variety of conventional metals and metal alloys including steel. Armature 26 is annular in construction and disposed about axis 30. Armature 26 is axially spaced from rotor 18 by an air gap. Like rotor disc 44, armature 26 includes a plurality of radially spaced rows of angularly spaced slots 98 that facilitate travel of magnetic flux back and forth between rotor 18 and armature 26 upon energization of conduction assembly 22. In the illustrated embodiment, armature 26 includes two rows of slots 98. The radially inner row of slots 98 on armature 26 is disposed between the radially inner and radially center row of slots 54 on rotor disc 44. The radially outer row of slots 98 on armature 26 is disposed between the radially center and radially outer rows of slots 54 on disc 44. It should be understood that the number of rows of slots 98 on armature 26, the number of slots 98 in any one row, and the size and shape of slots 98 may vary. Armature 26 is coupled to output member 14. In particular, armature 26 may be coupled to output member 14 by a plurality of leaf springs 100. Springs 100 transmit drive and braking torque from armature 26 to output member 14 and allow for axial movement of armature 26 relative to member 14 and towards and away from rotor disc 42. Springs 100 may be made from stainless steel and are connected at one end to armature 26 and at an opposite end to output member 14 using conventional fasteners 102 such as rivets, screws, bolts, or pins.

Magnets 28 are provided to create a magnetic circuit between brake plate 24 and armature 26 to draw armature 26 into engagement with brake plate 24 and provide a braking torque to output member 14. Magnets 28 may comprise neodymium iron boron (Nd—Fe—B) magnets or other known permanent magnets. Referring to FIG. 2, magnets 28 may be embedded within a closed bore 104 in brake plate 24 and may be arranged such that one face of the magnet 28 is flush with one side (and the engagement surface) of brake plate 24. Referring to FIG. 1, magnets 28 may be arcuately spaced from one another about the circumferential extent of brake plate 24. A single magnet 28 may be disposed in each tab 94 wherein slots 96 serve to magnetically isolate each magnet 28 from other magnets 28. Alternatively, more than one magnet 28 may be disposed in a single tab 94 (and/or slots 96 eliminated) provided that the magnets 28 are appropriately spaced from one another. Magnets 28 may also be disposed in every other tab 94 to increase wear surface. It will further be appreciated that the number and location of magnets 28 within brake plate 24 may vary depending upon the characteristics of device 10 and related design requirements. As illustrated, magnets 28 are arranged such that the facing poles of adjacent magnets are of like polarity thereby forming parallel magnetic circuits. Alternatively, magnets 28 may be arranged such that the facing poles of adjacent magnets 28 are of opposite polarity thereby forming a less efficient series magnetic circuit. Referring again to FIG. 2, magnets 28 are axially aligned with a portion of armature 26 and are oriented such that magnetic flux travels axially through said magnets 28.

Although a particular form of rotational coupling device is illustrated in FIGS. 1-2, it should be understood that the rotational coupling device of the rotational coupling device and installation tool kit described herein may vary and that the installation tools described below can be used with a variety of different rotational coupling devices. For example, although device 10 acts as both a clutch and a brake, the device may be configured to act as a clutch alone or a brake alone. Although device 10 is actuated using electromagnetic force, device 10 could alternatively be actuated through fluid (pneumatic or hydraulic) forces. The kit described herein may include, and the installation tools described herein may be used with, any rotational coupling device that is configured for mounting on a shaft such as input shaft 12 and that includes a hub, such as hub 16, that is configured to be disposed about a rotational axis 30 of the shaft 12 and spaced from the shaft 12 and that includes a bore 34 configured to be centered about the rotational axis 30, aligned with a corresponding bore 32 in the shaft 12 and receive a fastener extending along the rotational axis 30 and through the bore 34 in the hub 16 and into the bore 32 in shaft 12.

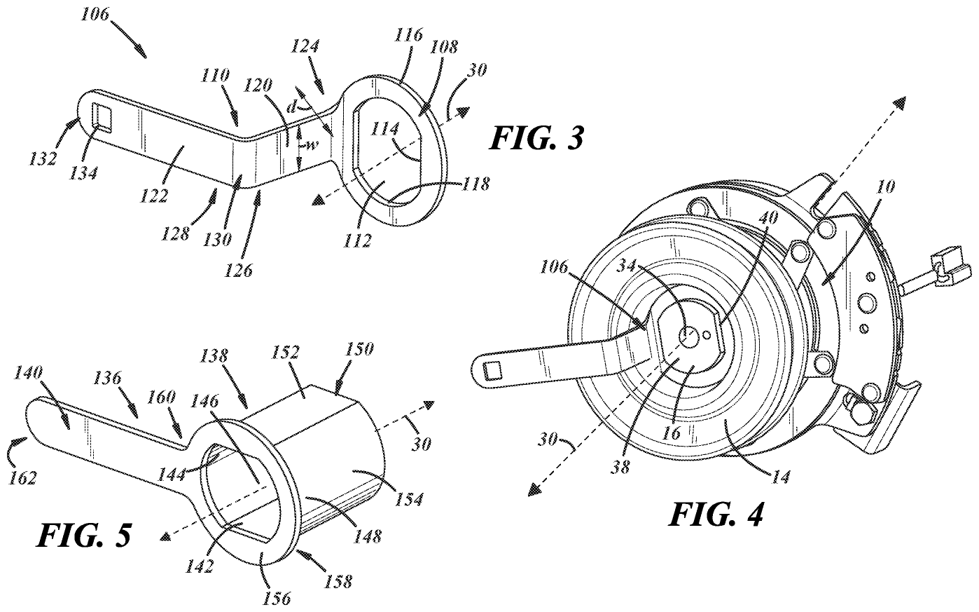

Referring now to FIG. 3, one embodiment of a tool 106 for installing a rotational coupling device such as device 10 on a shaft such as input shaft 12 is shown. Tool 106 includes a body 108 and an arm 110.

Body 108 is configured to receive an engage hub 16 and, in particular to engage flange 38 of hub 16. Body 108 may be annular in shape and defines an aperture 112 extending therethrough. Referring to FIG. 4, during use, aperture 112 is configured to be positioned about axis 30 extending through input shaft 12, hub 16 and the fastener (not shown) extending through bore 34 of hub 16 into bore 32 of input shaft 12. Aperture 112 has a shape complementary to a shape of flange 38 of hub 16 and aperture 112. Referring again to FIG. 3, aperture 112 defines at least one flat 114. Flat 114 is configured for engagement with a corresponding flat 40 on flange 38 of hub 16. Flats 40 and 114 cooperate to prevent relative rotation between hub 16 and tool 106. In the illustrated embodiment, the radially outer surface 116 of body 108 is circular in shape and aperture 112 defines a pair of diametrically opposed flats 114 that are separated by curved or arcuate segments 118. It should be understood, however, that the shape of body 108 may vary so long as aperture 112 (which may be open or closed) has a shape complementary to the shape of hub 16 and defines at least one flat 114 configured to engage a corresponding flat 40 on hub 16 to inhibit relative rotation between hub 16 and tool 106.

Arm 110 extends from body 108 and is provided to allow the user to inhibit or prevent movement of tool 106 and, as a result, hub 16 of device 10 and input shaft 12 as the fastener extending through bore 34 of hub 16 and into bore 32 of input shaft 12 is rotated to secure device 10 onto input shaft 12. In the illustrated embodiment, arm 110 includes an axially extending portion 120 and a radially extending portion 122.

Portion 120 extends from body 108 in a direction that is parallel or substantially parallel to axis 30. Referring again to FIG. 4, the configuration of portion 120 of arm 110 allows body 108 of tool 106 to engage hub 16 of device 10 even in cases where hub 16 is deeply recessed within output member 14. Referring again to FIG. 3, portion 120 is generally rectangular in shape and each side of portion 120 is flat. It should be understood, however, that the shape of portion 120 may vary. A first axial end 124 of portion 120 is coupled to body 108 and a second axial end 126 of portion 120 is coupled to portion 122 of arm 110. The width w of portion 120 is constant except at end 124 of portion 120 where the width of portion 120 increases as portion 120 meets body 108. Similarly, the depth d of portion 120 is constant except at end 124 of portion 120 where the depth of portion 120 decreases as portion 120 meets body 108.

Portion 122 extends radially from portion 120 of arm 110 in a direction perpendicular to, or substantially perpendicular to, axis 30 and away from axis 30. Portion 122 is also generally rectangular in shape and each side of portion 122 is flat. One end 128 of portion 122 is coupled to end 126 of portion 120 of arm 110. End 128 of portion 122 and end 126 of portion 120 together define a curved transition section 130 that has an arc of ninety (90), or about ninety, degrees. An opposite end 132 of portion 122 defines a semicircular edge and defines an aperture 134 that may be used to fix arm 110 to a fixed structure to inhibit movement of tool 106 and/or to mount tool 106 on a peg or other structure when tool 106 is not in use. In the illustrated embodiment, aperture 134 is square in shape, but it should be understood that the shape of aperture 134 may vary.

Referring now to FIG. 5, another embodiment of a tool 136 for installing a rotational coupling device such as device 10 on a shaft such as input shaft 12 is shown. Tool 136 includes a body 138 and an arm 140.

Body 138 is configured to receive an engage hub 16 and, in particular to engage flange 38 of hub 16. Body 138 may be annular in shape and defines an aperture 142 extending therethrough. During use, aperture 142 is configured to be positioned about axis 30 extending through input shaft 12, hub 16 and the fastener (not shown) extending through bore 34 of hub 16 into bore 32 of input shaft 12. Aperture 142 has a shape complementary to a shape of flange 38 of hub 16 and aperture 142 defines at least one flat 144. Flat 144 is configured for engagement with a corresponding flat 40 on flange 38 of hub 16. Flats 40 and 144 cooperate to prevent relative rotation between hub 16 and tool 136. In the illustrated embodiment, aperture 142 defines a pair of diametrically opposed flats 144 that are separated by curved or arcuate segments 146. Further, the shape of a radially outer surface of body 138 varies along its axial length. One portion 148 of body 138 defining a first axial end 150 of body 138 is configured to engage hub 16 during use of tool 136 and has a radially outer surface with a shape corresponding to the shape of aperture 142. In particular, portion 148 defines a pair of diametrically opposed flat sides 152 that are separated by diametrically opposed curved or arcuate sides 154. Another portion 156 of body 138 defining a second axial end 158 of body 138 is spaced from hub 16 during use of tool 136 and is circular in shape and projects further outward in every radial direction from axis 30 relative to portion 148 of body 138. It should again be understood that the shape of body 138 may vary so long as aperture 142 (which may be open or closed) has a shape complementary to the shape of hub 16 and defines at least one flat 144 configured to engage a corresponding flat 40 on hub 16 to inhibit relative rotation between hub 16 and tool 136.

Arm 140 extends from body 138 and is provided to allow the user to inhibit or prevent movement of tool 136 and, as a result, hub 16 of device 10 and input shaft 12 as the fastener extending through bore 34 of hub 16 and into bore 32 of input shaft 12 is rotated to secure device 10 onto input shaft 12. Arm 140 extends from end 158 of body 138 in a direction perpendicular to, or substantially perpendicular to, axis 30 and away from axis 30. Arm 140 generally rectangular in shape and each side of arm 140 is flat. One end 160 of arm 140 is coupled to end 158 of body 138. An opposite end 162 of arm 140 defines a semicircular edge and may define an aperture similar to aperture 134 in tool 106 that may be used to fix arm 140 to a fixed structure to inhibit movement of tool 136 and/or to mount tool 136 on a peg or other structure when tool 136 is not in use.

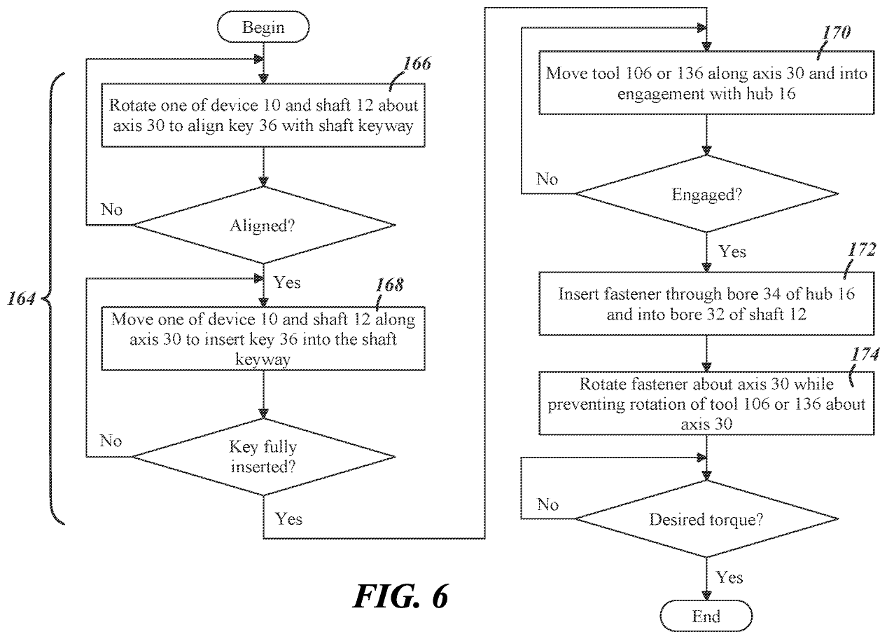

Referring now to FIG. 6, a method of installing a rotational coupling device 10 will be described. The method may begin with the step 164 of mounting device 10 onto input shaft 12. If replacing an existing rotational coupling device, step 164 may be preceded by steps relating to removal of the existing rotational coupling device and preparation (e.g., cleaning) input shaft 12. Step 164 may include several substeps 166, 168. In substep 166, one of device 10 and shaft 12 is rotated about axis 30 relative to the other of device 10 and shaft 12 to align key 36 on rotor hub 42 with a keyway in shaft 12. In substep 168, one of device 10 and shaft 12 is moved along axis 30 relative to the other of device 10 and shaft 12 to move key 36 into the keyway in shaft 12. Upon completion of substep 168, hub 16 is disposed about rotational axis 30 of shaft 12 and spaced from shaft 12 and bore 34 in hub 16 is centered about axis 30 and aligned with bore 32 in shaft 12. The method may continue with the step 170 of moving a tool 106 or 136 along axis 30 and into engagement with hub 16. In particular, body 108 of tool 106 or body 138 of tool 136 is moved along axis 30 until flange 38 of hub 16 enters into aperture 112 or 142 of the corresponding tool 106, 136. As a result, flats 114 or 144 of the corresponding tool 106, 136 engage flags 40 on flange 38 of hub 16. Once tool 106 or 136 is engaged with hub 16, the method may continue with the step 172 of inserting a fastener through bore 34 of hub 16 and into bore 32 of shaft 12. Thereafter, the method may continue with the step 174 of rotating the fastener about axis 30 while simultaneously preventing rotation of tool 106, 136 about axis 30 until the fastener is tightened to the desired torque. By preventing rotation of tool 106 or 136, hub 16 of device 12 is prevented from rotating about axis 30 due to the interface of flats 114 or 144 on tool 106 or 136, respectively, and flats 40 on flange 38 of hub 16. Further, due to the interface of key 36 in the aligned keyways in shaft 12 and hub 16, rotation of shaft 12 about axis 30 is prevented. In this manner, the rotation and tightening of the fastener does not result in rotation of shaft 12 thereby preventing misalignment of device 10 and shaft 12 and tightening of the fastener to the desired torque.

An installation tool 106 or 136 for a rotational coupling device 10, a rotational coupling device 10 and installation tool 106 or 136 kit and a method for installing a rotational coupling device 10 in accordance with the present teachings represents an improvement as compared to conventional tools, kits and methods. In particular, the inventive tool 106 or 136, kit 10, 106 or 136 and method enables an installer to prevent rotation of the rotational coupling device hub 16, and therefore the shaft 12 on which the rotational coupling device 10 is mounted, during rotation of the fastener used to secure the rotational coupling device 10 on the shaft 12 even in devices where the hub 16 is deeply recessed within a pulley 14 or another component of the device 10. As a result, the alignment of the shaft 12 and the rotational coupling device 10 may be maintained and the fastener may be tightened to the desired torque without resorting to time-consuming and/or unsafe methods of engaging the hub and rotating the input shaft 12.

While the invention has been shown and described with reference to one or more particular embodiments thereof, it will be understood by those of skill in the art that various changes and modifications can be made without departing from the spirit and scope of the invention.

What is claimed is:

1. A tool for installing a rotational coupling device on a shaft, comprising:
a body defining an aperture configured to be positioned about an axis extending through the shaft, a hub of the rotational coupling device and a fastener extending through the hub and into the shaft, the aperture having a shape complementary to a shape of the hub of the rotational coupling device and defining at least one flat; and,
an arm extending from the body, the arm including
an axially extending portion extending from the body in a direction parallel to the axis; and,
a radially extending portion extending from the axially extending portion in a direction perpendicular to, and away from, the axis.

2. The tool of claim 1 wherein the body is annular in shape.

3. The tool of claim 1 wherein the aperture defines first and second diametrically opposed flats.

4. The tool of claim 1 wherein the radially extending portion of the arm includes a first end connected to the axially extending portion of the arm, a second end opposite the first end, and an aperture proximate the second end.

5. A rotational coupling device and installation tool kit, comprising:
a rotational coupling device configured for mounting on a shaft, the rotational coupling device having a hub configured to be disposed about a rotational axis of the shaft and spaced from the shaft, the hub having a bore configured to be centered about the rotational axis, aligned with a corresponding bore in the shaft and receive a fastener extending along the rotational axis and through the bore in the hub and into the bore in the shaft; and,
a tool for installing the rotational coupling device on the shaft, the tool including
a body defining an aperture configured to be positioned about the rotational axis and receive the hub of the rotational coupling device, the aperture having a shape complementary to a shape of the hub and defining at least one flat; and,
an arm extending from the body, at least a portion of the arm configured to be axially spaced from the hub and extending in a direction perpendicular to, and away from, the rotational axis
wherein the tool is configured to be fixed against movement about the rotational axis as the fastener is rotated into the hub of the rotational coupling device and the shaft.

6. The rotational coupling device and installation tool kit of claim 5 wherein the arm includes
an axially extending portion extending from the body in a direction parallel to the rotational axis; and,
a radially extending portion extending from the axially extending portion in a direction perpendicular to, and away from, the rotational axis.

7. The rotational coupling device and installation tool kit of claim 6 wherein the radially extending portion of the arm includes a first end connected to the axially extending portion of the arm, a second end opposite the first end, and an aperture proximate the second end.

8. The rotational coupling device and installation tool kit of claim 5 wherein the body has a first axial end configured to receive the hub and a second axial end spaced from the hub and the arm extends from the second axial end of the body.

9. The rotational coupling device and installation tool kit of claim 5 wherein the body is annular in shape.

10. The rotational coupling device and installation tool kit of claim 5 wherein the aperture defines first and second diametrically opposed flats.

11. A method of installing a rotational coupling device, comprising:
mounting a rotational coupling device onto a shaft such that a hub of the rotational coupling device is disposed about a rotational axis of the shaft and spaced from the shaft, the hub having a bore configured to be centered about the rotational axis and aligned with a corresponding bore in the shaft;
moving a tool along the rotational axis and into engagement with the hub, the tool including a body defining an aperture having a shape complementary to a shape of the hub of the rotational coupling device and defining at least one flat and an arm extending from the body in a direction perpendicular to, and away from, the rotational axis, at least a portion of the arm axially spaced from the hub of the rotational coupling device;
inserting a fastener through the bore of the hub and into the bore of the shaft;
rotating the fastener about the rotational axis while preventing rotation of the tool about the rotational axis to thereby prevent rotation of the hub of the rotational coupling device and the shaft.

12. The method of claim 11 wherein the arm of the tool includes:
an axially extending portion extending from the body in a direction parallel to the rotational axis; and,
a radially extending portion extending from the axially extending portion in a direction perpendicular to, and away from, the rotational axis.

13. The method of claim 12 wherein the radially extending portion of the arm includes a first end connected to the axially extending portion of the arm, a second end opposite the first end, and an aperture proximate the second end.

14. The method of claim 11 wherein the body has a first axial end configured to receive the hub and a second axial end spaced from the hub and the arm extends from the second axial end of the body.

15. The method of claim 11 wherein the body is annular in shape.

16. The method of claim 11 wherein the aperture defines first and second diametrically opposed flats.

17. The method of claim 11, wherein mounting the rotational coupling device onto the shaft includes
rotating one of the rotational coupling device and the shaft about the rotational axis relative to the other of the rotating coupling device to align a key of the rotational coupling device disposed in a keyway in the hub with a keyway in the shaft; and,
moving one of the rotational coupling device and the shaft along the rotational axis relative to the other of the rotational coupling device and the shaft to move the key into the keyway in the shaft.
